(19) United States
(12) Patent Application Publication
(10) Pub. No.: US 2019/0094778 A1
(43) Pub. Date: Mar. 28, 2019

(54) IMAGE FORMING APPARATUS, PROCESSING METHOD AND NON-TRANSITORY RECORDING MEDIUM

(71) Applicants: KABUSHIKI KAISHA TOSHIBA, Tokyo (JP); TOSHIBA TEC KABUSHIKI KAISHA, Tokyo (JP)

(72) Inventor: Yoshihiro Tsujimura, Mishima Shizuoka (JP)

(21) Appl. No.: 15/713,870

(22) Filed: Sep. 25, 2017

(51) Int. Cl. G03G 15/00; G03G 21/16

(52) U.S. Cl. CPC G03G 15/502; G03G 21/1652; G03G 2215/00675; G03G 21/1647; G03G 15/5004; G03G 2221/166

(57) ABSTRACT

In accordance with an embodiment, an image forming apparatus comprises an external connection control section, a determination section and a guidance control section. The external connection control section controls connection with an external device. The determination section determines a type of the external device connected with the image forming apparatus. The guidance control section selects, on the basis of a determination result of the determination section, a message of guidance and displays the message on a display device.

### FIELD

Embodiments described herein relate generally to an image forming apparatus, a processing method, and a non-transitory recording medium.

### BACKGROUND

In recent years, a system for reducing a load applied to environment is executed as a system relating to ecology (hereinafter, also referred to as “eco”). The ecology can also be useful for energy conservation (so-called “energy saving”). For example, even in a case in which a user carries out printing or copying by an image forming apparatus, it is desired to reduce the load applied to environment. In the case of printing or copying, for example, it is possible to reduce the price of papers by decreasing the number of printing or copying sheets. Further, in the case of printing or copying, it is possible to reduce the price of ink, for example, by decreasing color printing or color copying. Further, in the case of printing or copying, for example, it is possible to reduce the price of papers and the environmental load by carrying out printing or copying with decoloring toner.

However, there is a case in which a user does not know a method for reducing the environmental load. Further, there is a case in which the user has no concern about the ecology.

### BRIEF DESCRIPTION OF THE DRAWINGS

FIG. 1 is an external view illustrating an example of an entire constitution of an image forming apparatus according to an embodiment;

FIG. 2 is a diagram illustrating an example of functional components of the image forming apparatus according to the embodiment;

FIG. 3 is a diagram illustrating an example of functional components of a control section according to the embodiment;

FIG. 4 is a diagram illustrating an example of an image of a message for recommending ecology according to the embodiment;

FIG. 5 is a diagram illustrating another example of an image of a message for recommending ecology according to the embodiment;

FIG. 6 is a diagram illustrating an example of a flow of a processing for changing setting relating to recommendation of ecology by the image forming apparatus according to the embodiment;

FIG. 7 is a diagram illustrating an example of a flow of a processing for carrying out printing by the image forming apparatus according to the embodiment;

FIG. 8 is a diagram illustrating an example of a flow of a processing for adjusting a message depending on the content of a job by the image forming apparatus according to the embodiment; and

FIG. 9 is a diagram illustrating an example of a user management table according to the embodiment.

### DETAILED DESCRIPTION

In accordance with an embodiment, an image forming apparatus comprises an external connection control section, a determination section and a guidance control section. The external connection control section controls connection with an external device. The determination section determines a type of the external device connected with the image forming apparatus. The guidance control section selects, on the basis of a determination result of the determination section, a message of guidance and displays the message on a display device.

Hereinafter, an image forming apparatus according to an embodiment is described with reference to the accompanying drawings. In each figure, the same reference numerals are applied to the same elements. Hereinafter, an image forming apparatus 100 is exemplified and described as an example of the image forming apparatus.

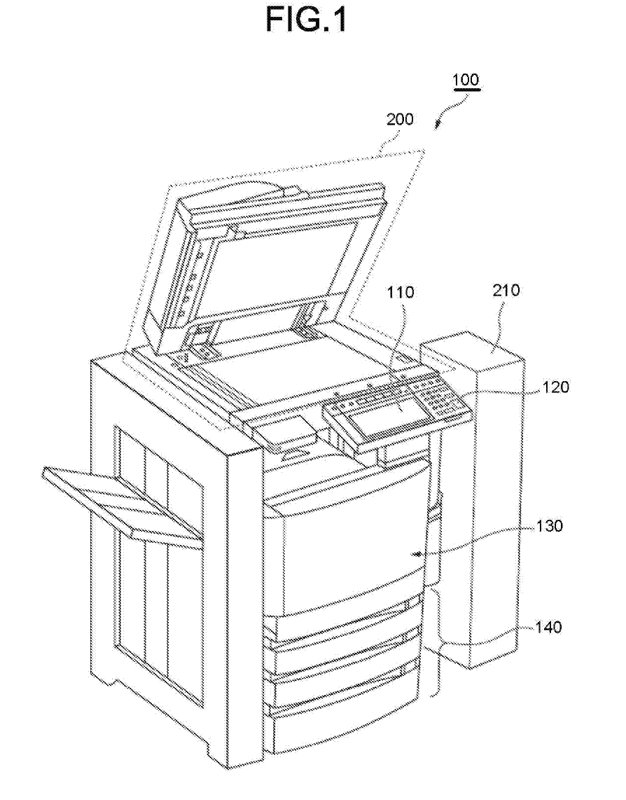

Hereinafter, details of the image forming apparatus 100 are described with reference to FIG. 1.

FIG. 1 is an external view illustrating an example of an entire constitution of the image forming apparatus 100 according to the embodiment. The image forming apparatus 100 is, for example, a multi-functional peripheral. The image forming apparatus 100 includes a display 110, a control panel 120, a printer section 130, a sheet housing section 140, and an image reading section 200. Furthermore, the printer section 130 of the image forming apparatus 100 may be an electrophotographic type device for fixing a toner image or an inkjet type device.

Further, an external device 210 connected with the image forming apparatus 100 is shown in FIG. 1.

The image forming apparatus 100 forms an image on a sheet with a developing agent such as toner. The sheet is, for example, a paper. Furthermore, the sheet may be an optional sheet as long as the image forming apparatus 100 can form an image on the surface of the sheet, such as a label paper.

The display 110 is a display device such as a liquid crystal display, an organic EL (Electro Luminescence) display and the like. The display device is, for example, an image display device for displaying images such as characters or figures. The display 110 displays various kinds of information relating to the image forming apparatus 100. It is possible that the display 110, for example, displays a message to a user.

The control panel 120 has a plurality of buttons. The control panel 120 receives an operation of a user. The control panel 120 outputs a signal corresponding to an operation carried out by the user to a control section of the image forming apparatus 100. Furthermore, the display 110 and the control panel 120 can be separate or both may be integrated into a single touch panel.

The printer section 130 forms an image on a sheet on the basis of image information generated by the image reading section 200 or image information received via a communication path. The printer section 130 forms the image through, for example, the following processing. The image forming section of the printer section 130 forms an electrostatic latent image on a photoconductive drum on the basis of the image information. The image forming section of the printer section 130 enables a developing agent to adhere to the electrostatic latent image to form a visible image. As a concrete example of the developing agent, toner is exemplified. The transfer section of the printer section 130 transfers the visible image on the sheet. The fixing section of the printer section 130 heats and pressures the sheet to enable the visible image to be fixed on the sheet. Furthermore, the sheet on which the image is formed may be a sheet housed in the sheet housing section 140 or a manually fed sheet.

The printer section 130 has, for example, a function for carrying out printing or copying with normal toner and a function for carrying out printing or copying using decoloring toner. Herein, the normal toner indicates toner which is not the decoloring toner.

Further, the printer section 130 has a function for erasing an image transferred on a sheet through the decoloring toner. Furthermore, a functional section for carrying out erasure of the decoloring toner in this way may be provided in the image forming apparatus 100, separately from the printer section 130, for example.

The sheet housing section 140 houses a sheet used for image formation by the printer section 130. The sheet housing section 140 has, for example, a function of a sheet cassette section which supplies a sheet on which an image is to be printed.

The image reading section 200 reads the image information of a read object as intensity of light. The read object is, for example, a document sheet. The image reading section 200 records the read image information. The recorded image information may be sent to another information processing apparatus via a network. The recorded image information may be used for the image formation on the sheet by the printer section 130.

Further, the image forming apparatus 100 may include, for example, a toner cartridge section (not shown) which supplies toner for forming an image on a sheet.

The external device 210 is a device additionally connected with the image forming apparatus 100. A concrete example of the external device 210 is a payment reception device for receiving payment of fees such as a printing fee or a copying fee. The payment reception device may be a coin controller device for receiving payment with coins as an example. Further, the payment reception device may be a device for receiving payment with an IC card as another example. The payment reception device is used in, for example, a store such as a convenience store (hereinafter, also referred to as a “conbini”). Further, another concrete example of the external device 210 is an authentication device for carrying out authentication of a user (hereinafter, in the embodiment, simply referred to as an “authentication device”). The authentication device is used in, for example, an office of a company.

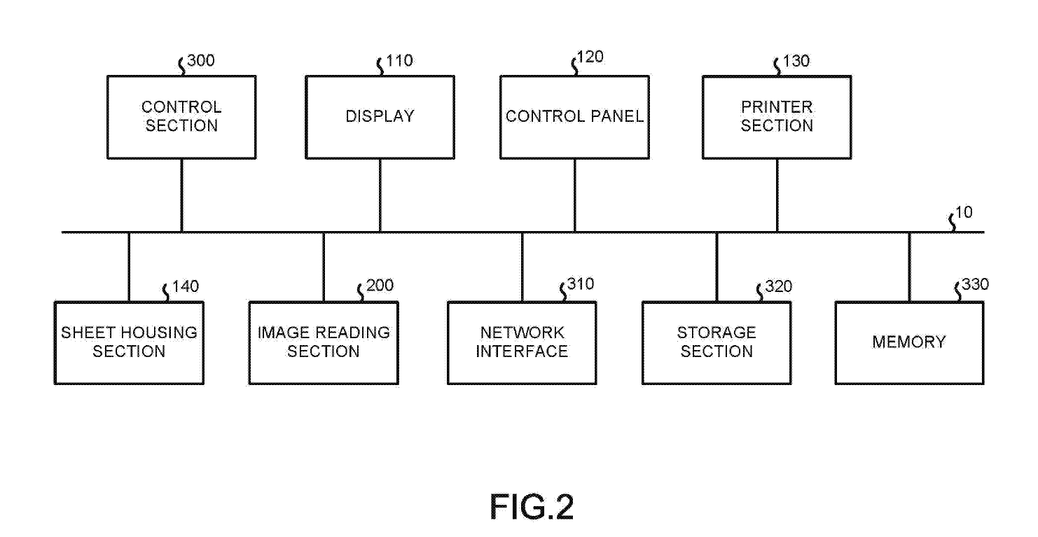

Hereinafter, functional components of the image forming apparatus 100 are described with reference to FIG. 2.

FIG. 2 is a diagram illustrating an example of the functional components of the image forming apparatus 100 according to the embodiment.

The image forming apparatus 100 includes a control section 300, the display 110 and the control panel 120. The image forming apparatus 100 further includes the printer section 130, the sheet housing section 140 and the image reading section 200. The image forming apparatus 100 further includes a network interface 310, a storage section 320 and a memory 330. These respective functional sections included by the image forming apparatus 100 are connected in a communicable manner via a system bus 10.

The descriptions of the display 110, the control panel 120 and the printer section 130 are the same as those described above, and thus are omitted. Further, the descriptions of the sheet housing section 140 and the image reading section 200 are the same as those described above, and thus are omitted. Hereinafter, the control section 300, the network interface 310, the storage section 320 and the memory 330 are described.

The control section 300 includes a CPU (Central Processing Unit) of the image forming apparatus 100. The control section 300 controls operations of respective functional sections of the image forming apparatus 100. The control section 300 executes various processing by executing a program. The control section 300 acquires, from the control panel 120, an instruction input by the user. In other words, the control section 300 receives an operation from the user by the control panel 120. The control section 300 executes a control processing on the basis of the acquired instruction.

The network interface 310 carries out transmission and reception of data with another device. The network interface 310 operates as an input interface and receives data transmitted from another device. Further, the network interface 310 operates as an output interface, and transmits data to another device.

The storage section 320 is, for example, an auxiliary storage device such as a hard disk, an SSD (Solid State Drive) and the like. The storage section 320 stores various data.

The memory 330 is, for example, a RAM (Random Access Memory). The memory 330 temporarily stores data used by each functional section included by the image forming apparatus 100. Furthermore, the memory 330 may store data generated by the image reading section 200, a program for operating respective functional sections, and the like.

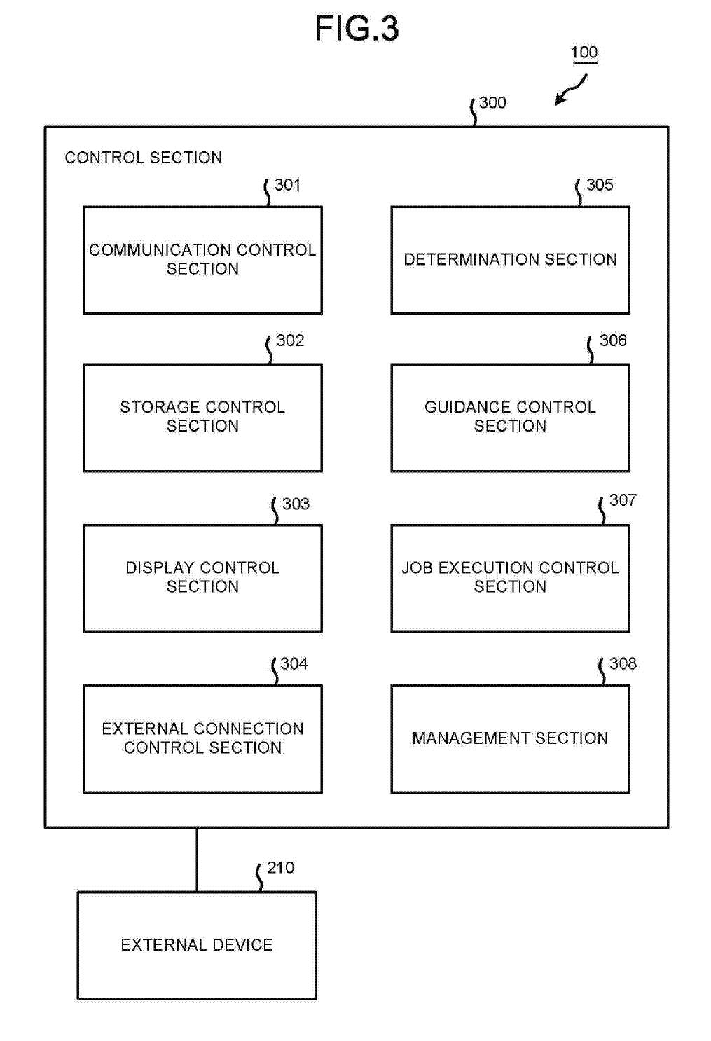

Hereinafter, functional components of the control section 300 are described with reference to FIG. 3.

FIG. 3 is a diagram illustrating an example of the functional components of the control section 300 according to the embodiment. Furthermore, the external device 210 is also shown in FIG. 3.

The control section 300 includes a communication control section 301, a storage control section 302, a display control section 303, and an external connection control section 304. The control section 300 includes a determination section 305, a guidance control section 306, a job execution control section 307, and a management section 308. Furthermore, some or all of these functional sections may be hardware functional sections such as an LSI (Large Scale Integration) or an ASIC (Application Specific Integrated Circuit).

The communication control section 301 carries out communication with another device via the network interface 310. Another device may be any device. Another device may be, for example, another image forming apparatus or a personal computer. The communication control section 301 may, for example, carry out control for transmitting or receiving a signal of a FAX to or from another device. Further, the communication control section 301 may, for example, carry out control for transmitting or receiving a signal of data to or from another device.

The storage control section 302 carries out storage of information and elimination of the stored information on the storage section 320 and the memory 330, respectively.

The display control section 303 generates various kinds of image depending on an operation received from the user. The display control section 303 enables the display 110 to display the generated images.

The external connection control section 304 carries out communication with the external device 210. Furthermore, the external connection control section 304 may be integrated with the communication control section 301.

The determination section 305 determines a type of the external device 210 connected with the image forming apparatus 100. For example, the external device 210 transmits information indicating the type of the external device 210 to the image forming apparatus 100. This information is received by the external connection control section 304. The determination section 305 determines the type of the external device 210 on the basis of the information received by the external connection control section 304. As the type of the external device 210, for example, there is the payment reception device and the authentication device.

The guidance control section 306 generates an image of a message for recommending ecology by the display control section 303, and enables the display 110 to display the generated image. The guidance is carried out through this message.

Herein, in the present embodiment, the ecology means that fees relating to resources are reduced by decreasing an amount of consumption of the resources. Further, since the amount of consumption of the resources is decreased, an environmental load can also be reduced. Any resource may be used as the resources. For example, papers, ink and the like may be used as the resources.

The job execution control section 307 controls execution of a job such as a print job or a copy job. Herein, any job may be used as a job executed by the job execution control section 307. In the present embodiment, the print job is described below as an example. The job may be, for example, monochrome printing, color printing, and printing with decoloring toner. Further, the job execution control section 307 may has, for example, a function for erasing the decoloring toner from a sheet printed with the decoloring toner.

The management section 308 manages a counter relating to jobs and information relating to an eco-point. The management section 308, for example, counts a value of a counter depending on a condition of an output processing such as printing. Further, the management section 308, for example, counts a value of an eco-point depending on the value of the counter. Herein, in the present embodiment, the eco-point is a point of a user relating to the ecology. Furthermore, the eco-point may be referred to by any other name.

Any job in which the ecology is realized may be used as a job in which the eco-point is granted (restored). For example, the eco-point may be granted to a job in which the number of printing sheets is reduced, like duplex printing or intensive printing. For example, the eco-point may be granted to a job in which a load applied to environment is reduced, like the printing with decoloring toner. For example, the eco-point may be granted to a job in which color data is printed as monochrome.

Further, the eco-point may be managed by, for example, a server device provided outside the image forming apparatus 100 (hereinafter, also referred to as “external management device”). In this case, for example, the image forming apparatus 100 and the external management device are connected in a communicable manner via a network. Then, the management section 308 communicates the information relating to the eco-point with the external management device.

Herein, the determination section 305, the guidance control section 306, the job execution control section 307 and the management section 308 may use functions of other functional sections when carrying out respective control. As the functions of other functional sections called herein, for example, there is communication control by the communication control section 301 and storage control by the storage control section 302. Further, as the functions of other functional sections called herein, for example, there is display control by the display control section 303 and connection control with the external device 210 by the external connection control section 304.

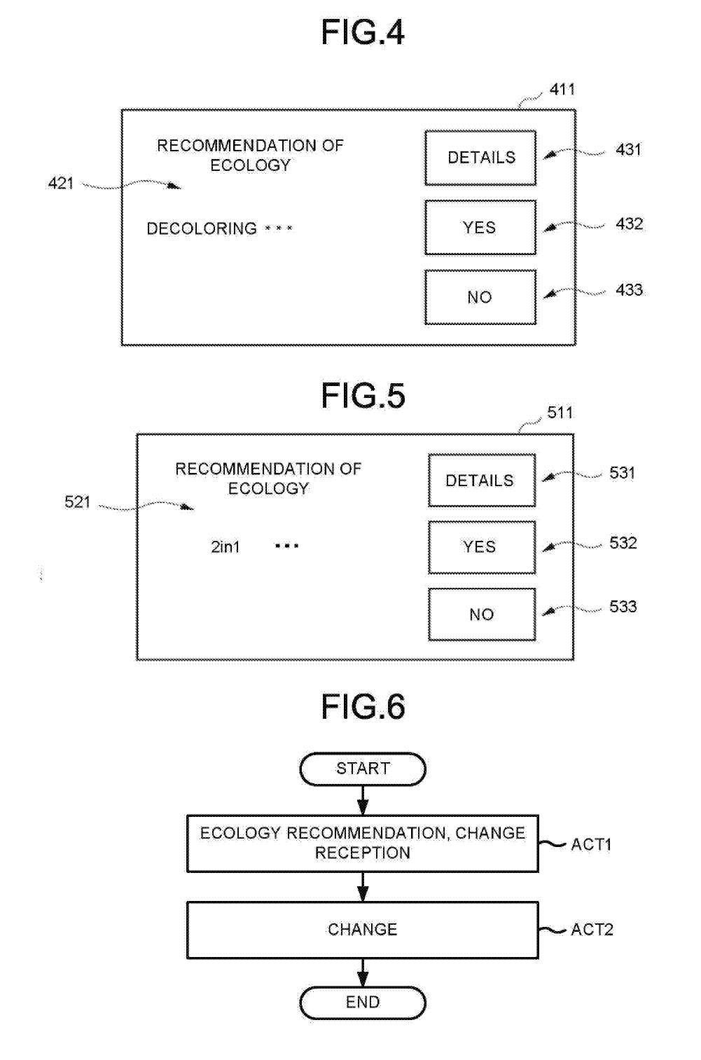

Hereinafter, an example of an image of a message for recommending ecology is described with reference to FIG. 4.

FIG. 4 is a diagram illustrating an example of an image 411 of a message for recommending ecology according to the embodiment.

The image 411 of the message assumes a case in which the payment reception device is used as the external device 210 in the store. In other words, it is assumed that the type of the external device 210 referred to as the payment reception device is associated with the image 411 of the message shown in FIG. 4.

The image 411 of the message is an example in which the touch panel is assumed. The image 411 of the message includes character information 421 and three buttons 431 to 433 as display information. The character information 421 is character information relating to recommendation of ecology and decoloring. The button 431 receives an instruction of detailed information from the user. The button 432 receives a positive instruction (YES) from the user. The button 433 receives a negative instruction (NO) from the user.

The control section 300 enables the display 110 to display detailed information relating to decoloring in a case of receiving the operation of the button 431. In a case of receiving the operation of the button 432 or the button 433, the control section 300 carries out control based on this instruction.

Furthermore, the control section 300 may receive an instruction from the user through a button other than the touch panel.

Herein, for a sheet to which the decoloring printing is carried out, an image on the sheet formed through this printing can be decolored through a decoloring processing. The decolored sheet can be recycled. In other words, the decoloring printing is useful for the ecology.

Hereinafter, another example of an image of a message for recommending ecology is described with reference to FIG. 5.

FIG. 5 is a diagram illustrating another example of an image 511 of a message for recommending ecology according to the embodiment.

The image 511 of the message assumes a case in which the authentication device is used as the external device 210 in the office. In other words, it is assumed that the type of the external device 210 referred to as the authentication device is associated with the image 511 of the message shown in FIG. 5.

The image 511 of the message is an example in which the touch panel is assumed. The image 511 of the message includes character information 521 and three buttons 531 to 533 as display information. The character information 521 is character information relating to recommendation of ecology and intensivism. The intensivism is, for example, 2in1. The button 531 receives an instruction of detailed information from the user. The button 532 receives a positive instruction (YES) from the user. The button 533 receives a negative instruction (NO) from the user.

The control section 300 enables the display 110 to display the detailed information relating to the intensive decoloring in a case of receiving the operation of the button 531. In a case of receiving the operation of the button 532 or the button 533, the control section 300 carries out control based on this instruction.

Furthermore, the control section 300 may receive an instruction from the user through a button other than the touch panel.

Herein, if the intensive printing is carried out, a plurality of pages of images is formed on one sheet. In other words, the intensive printing is useful for the ecology.

Furthermore, the same applies to the duplex printing in addition to the intensive printing.

Herein, other images may be used as an image of a message for recommending ecology. For example, in a case in which a user is authenticated, the image of the message for recommending the ecology may include information of a balance value of eco-points granted to the user. The balance value of eco-points indicates a value of accumulated eco-points.

Further, the guidance control section 306 may display an image of a message for recommending ecology on a screen at the time of user authentication. The image may include, for example, the information relating to the balance value of eco-points.

Further, the guidance control section 306 may usually display an image of a message for recommending ecology when other information is not displayed. As an example, in a case in which the payment reception device is connected with the image forming apparatus 100, the guidance control section 306 may display the image prior to payment. As another example, in a case in which the authentication device is connected with the image forming apparatus 100, the guidance control section 306 may display the image prior to authentication.

Further, the content of an image of a message for recommending ecology may be any content. As a concrete example, the image may include character information such as “People who want to save sheets, come this way” or “People who want to multiple printing, come this way”. For example, in a case in which the decoloring can be carried out next time after the printing with the decoloring toner is carried out, the image may include character information “An eco-point is received in the next decoloring”.

Hereinafter, a flow of a processing for changing setting relating to recommendation of ecology by the image forming apparatus 100 is described with reference to FIG. 6.

FIG. 6 is a diagram illustrating an example of the flow of the processing for changing the setting relating to the recommendation of the ecology by the image forming apparatus 100 according to the embodiment.

For the recommendation of the ecology, information in which the type of the external device 210 and the type of the message are associated with each other is stored in the storage section 320. This information is set, for example, by a maker at the time of shipment of the image forming apparatus 100. It is possible that the user changes the content of this setting.

In other words, the guidance control section 306 receives an instruction of the change relating to the recommendation of the ecology through the operation of the user (ACT 1). In this case, the guidance control section 306 carries out the change relating to the recommendation of the ecology according to the received instruction (ACT 2). For example, the guidance control section 306 carries out change on information stored in the storage section 320 according to the received instruction. The change is, for example, the change of the information in which the type of the external device 210 and the type of the message are associated with each other.

As an example, a plurality of types of messages may be stored in the storage section 320 at the time of the shipment of the image forming apparatus 100. Then, the guidance control section 306 may set any message of the plurality of types of messages depending on an operation of the user.

As another example, the guidance control section 306 may generate and set any message which is not stored at the time of the shipment depending on an operation of the user.

Furthermore, for example, these operations of the user may be carried out directly on the image forming apparatus 100. Further, for example, these operations of the user may be carried out on the image forming apparatus 100 via the network from the personal computer operated by the user.

The content of the message of the guidance in the image forming apparatus 100 may be set randomly, for example, for each any position. Each any position may be for example, each store, each company, or each branch store (or branch office) in a company.

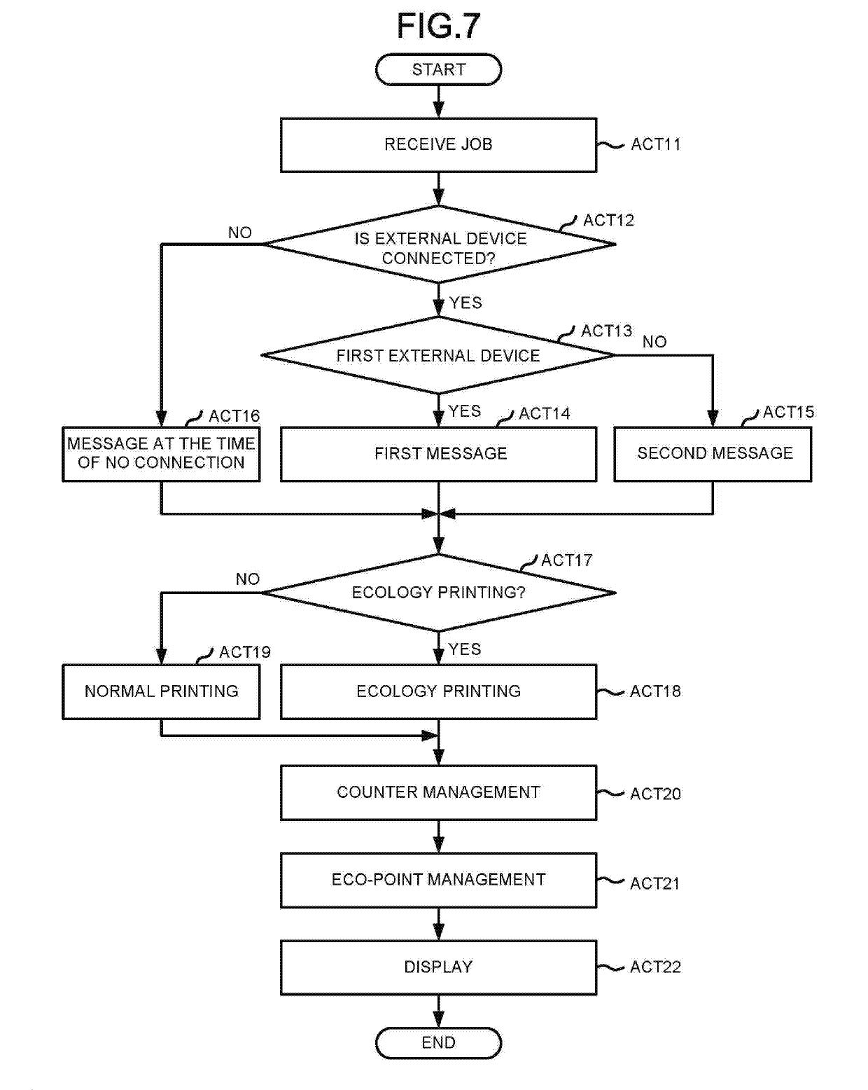

A processing for carrying out printing by the image forming apparatus 100 is described with reference to FIG. 7.

FIG. 7 is a diagram illustrating a flow of the processing for carrying out the printing by the image forming apparatus 100 according to the embodiment. Furthermore, the same applies to the copying instead of the printing.

In the present embodiment, the payment reception device serving as the external device 210 is referred to as a first external device. Further, in the present embodiment, the authentication device serving as the external device 210 is referred to as a second external device.

The job execution control section 307 receives a job through an operation of the user (ACT 11). In this case, the determination section 305 determines whether or not the external device 210 is connected with the image forming apparatus 100 (ACT 12). If the determination section 305 determines that the external device 210 is connected with the image forming apparatus 100 (YES in ACT 12), a processing in ACT 13 is carried out in the control section 300. On the other hand, if the determination section 305 determines that the external device 210 is not connected with the image forming apparatus 100 (NO in ACT 12), a processing in ACT 16 is carried out in the control section 300.

In the processing in ACT 13, the determination section 305 determines whether or not the external device 210 is the first external device (ACT 13). If the determination section 305 determines that the external device 210 is the first external device (YES in ACT 13), a processing in ACT 14 is carried out in the control section 300. On the other hand, if the determination section 305 determines that the external device 210 is not the first external device (NO in ACT 13), a processing in ACT 15 is carried out in the control section 300.

In the processing in ACT 14, the guidance control section 306 selects a first message and enables the display 110 to display an image of the first message (ACT 14).

In the processing in ACT 15, the guidance control section 306 selects a second message and enables the display 110 to display an image of the second message (ACT 15).

In the processing in ACT 16, if there is no connection with the external device 210, the display 110 displays an image of an associated message (ACT 16). The image of the message may be set particularly, for example, in a case in which there is no connection with the external device 210. Alternately, the image of the message may be, for example, in a normal state. As an example, in a normal state, an image of a home screen may be used as the image of the message. As another example, since no image is displayed normally, the screen of the image forming apparatus 100 may be in a power saving state.

After the processing in ACT 13 to ACT 16, the job execution control section 307 receives an instruction of printing through an operation of the user. Then, the determination section 305 determines whether or not an instruction of ecology printing is received (ACT 17). If the determination section 305 determines that the instruction of the ecology printing is received (YES in ACT 17), a processing in ACT 18 is carried out in the control section 300. On the other hand, if the determination section 305 determines that the instruction of the ecology printing is not received (NO in ACT 17), a processing in ACT 19 is carried out in the control section 300.

Herein, information for determining whether or not the printing is the ecology printing is stored in the storage section 320. For example, as a condition for determining the printing is the ecology printing, a condition for determining the printing is the ecology printing in a case in which the printing is one or more of a predetermined plurality of printing may be used. The predetermined plurality of printing may include, for example, one or more of the decoloring printing, the intensive printing or the duplex printing. For example, this condition may be set by the maker at the time of the shipment of the image forming apparatus 100, or the setting of this condition may be changed by the user.

In the processing in ACT 18, the job execution control section 307 enables the printer section 130 to execute the job of the ecology printing.

In the processing in ACT 19, the job execution control section 307 enables the printer section 130 to execute the job of the normal printing. Herein, the normal printing indicates a printing job which is not the ecology printing.

After the processing in ACT 18 or ACT 19, the management section 308 carries out management of a counter (ACT 20). This counter is a counter of a number relating to jobs executed in the printing of this time. This number is for example, the number of printed sheets or the number of printed pages. Furthermore, the management section 308 may carry out management such as updating of the value of the counter during one or more of periods “before the start of the printing”, “the printing is being executed” and “after the end of the printing”. Further, for example, the management section 308 may manage the value of the counter for each job content. The job content may be, for example, the normal printing, the duplex printing, the intensive printing, and the printing with decoloring toner.

Herein, in a case in which authentication of a user is carried out, the management section 308 may carry out management of a counter for each user. Further, in a case in which a plurality of image forming apparatuses 100 is associated, the management section 308 may carry out management of all counters of these multiple image forming apparatuses 100. For example, a plurality of image forming apparatuses 100 having the same attribute like the same company may be associated. Information for specifying the plurality of associated image forming apparatuses 100 may be stored, for example, in the storage section 320.

Next, the management section 308 carries out management of an eco-point (ACT 21). An eco-point of a user is increased according to a defined rule if the user executes a processing relating to ecology such as the ecology printing. Further, the eco-point of the user is decreased if the user receives a special favor such as discount using the eco-point. Furthermore, the management section 308 may carry out management such as updating of a value of an eco-point during one or more of periods “before the start of the printing”, “the printing is being executed” and “after the end of the printing”. Further, the management section 308 may store and hold the current eco-point of the user in the storage section 320. Furthermore, in the present example, the management section 308 manages an eco-point in a user unit; however, may manage an eco-point in other units. The management section 308 may manage an eco-point, for example, in unit of each image forming apparatus 100.

Next, the management section 308 enables the display 110 to display predetermined information (ACT 22). The information is, for example, one or more of information relating to completed printing, information relating to a counter or information relating to an eco-point.

Herein, a relationship between the value of the counter and the value of the eco-point may be the same value or different values. As an example, the value of the eco-point may be a value of a result obtaining multiplying a predetermined coefficient by the value of the counter. The predetermined coefficient may be any value. The predetermined coefficient may be, for example, a different value for each job. The eco-points are added, for example, depending on an execution amount of jobs contributing to the ecology.

Further, for example, it may be possible that the eco-point is transferred. The management section 308 may transfer the eco-point belonging to a certain device to another device. The management section 308 may enable the transfer of the eco-point, for example, at a point of time at which the eco-point belonging to a certain device reaches a predetermined value. The predetermined value may be any value. The predetermined value may be defined, for example, by an administrator of a system or a seller who issues an eco-point.

Further, any eco-point may be used. A service received by a user by consuming an eco-point may be any service. The service may be, for example, reduction of a predetermined price corresponding to an eco-point. The predetermined price may be any price. The predetermined price may be, for example, a printing fee or an ink fee. As an example, the number of printable sheets may be increased depending on a usage amount of eco-points. As another example, a discount amount of consumables or other accessories may be set depending on a usage amount of eco-points. It is possible that the use of the eco-points is randomly selected by the user.

Further, eco-points may be usable at any value (for example, a fraction), or may be usable in a state where the eco-points exceed a predetermined value (for example, a large number of points). Further, the eco-points may be used, for example, for each user. Further, the eco-points may be collectively used, for example, for each image forming apparatus. Further, the eco-points may be collectively used, for example, for each predetermined attribute like a company.

Further, a coupon corresponding to an eco-point may be issued to a user. The coupon may be an electronic coupon. The coupon may be, for example, an image that can be read by photographing with a camera function such as the smartphone of the user. It is possible to acquire an eco-point by accessing a Website corresponding to an image read through the camera function. The image may include, for example, information of a predetermined identifier (hereinafter, also referred to as “identifier information”). The identifier information may be any information. As an example, the identifier information may be information of a two-dimensional barcode for identifying the content of a service.

Further, an eco-point may be granted to a user, for example, by the image forming apparatus 100. Further, the eco-point may be granted to the user, for example, at a register of a store or in a specific department of a company.

Further, in the duplex printing, the intensive printing or a processing for printing colors in monochrome, for example, an eco-point may be granted at the time of printing. Further, in the printing with the decoloring toner, for example, the eco-point may be granted at the time of the next decoloring.

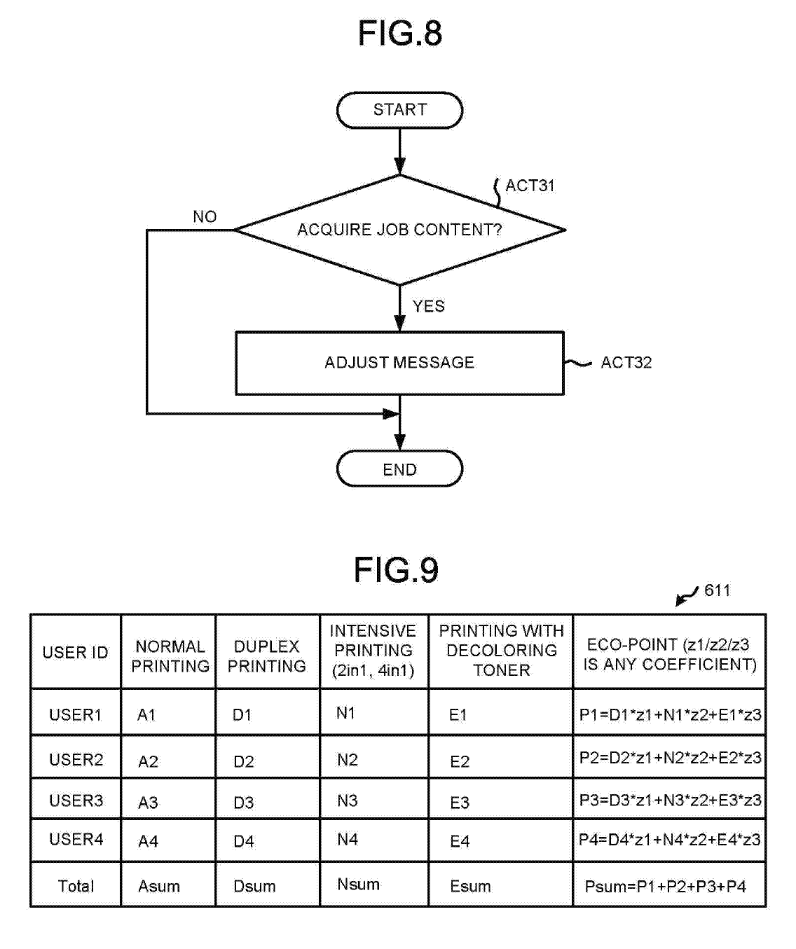

A processing for adjusting a message depending on the content of a job by the image forming apparatus 100 is described with reference to FIG. 8.

FIG. 8 is a diagram illustrating an example of a flow of the processing for adjusting a message depending on the content of a job by the image forming apparatus 100 according to the embodiment.

The determination section 305 determines whether or not the content of a job carried out by a user is acquired (ACT 31). If the determination section 305 determines that the content of the job carried out by the user is acquired (YES in ACT 31), a processing in ACT 32 is carried out in the control section 300. On the other hand, if the determination section 305 determines that the content of the job carried out by the user is not acquired (NO in ACT 31), the adjustment of the message is not carried out in the control section 300.

In the processing in ACT 32, the guidance control section 306 adjusts the content of the message on the basis of the acquired content of the job (ACT 32). As the adjustment of the message, for example, change of part or all of the content of the message may be carried out. As an example, the change of the content may be realized by selecting one from candidates of a plurality of contents prepared in advance. As another example, the change of the content may be realized by assuming the content of a result operated using a predetermined operating formula.

Herein, for example, in a case in which the content of the job can be grasped in advance, like network working, the guidance control section 306 refers to this content. In the network working, a user transmits data of a job from the computer of his/her home to the image forming apparatus 100 of a convenience store. The data becomes print data. Then, the image forming apparatus 100 executes the data of the job.

Further, the guidance control section 306 may display, for example, a screen for requiring an input of the content of a job to a user. Then, the guidance control section 306 may receive and refer to the content depending on an operation of the user.

Further, for example, in a case in which preview is instructed depending on an operation of the user, the guidance control section 306 may refer to the content of a job on the basis of the preview.

It is possible that the guidance control section 306 carries out the adjustment of the message on the basis of, for example, the number of printing sheets, or it being colored or not.

A user management table 611 is described with reference to FIG. 9.

FIG. 9 is a diagram illustrating an example of the user management table 611 according to the embodiment.

The management section 308 manages, by the user management table 611, information relating to jobs carried out by a plurality of users.

The user management table 611 has columns “user ID”, “normal printing”, “duplex printing”, “intensive printing (2in1, 4in1)”, “printing with decoloring toner”, and “eco-points”. Information of these columns is associated with each of respective users. The information of the column of “user ID” is information for identifying a user. The information of the column of “user ID” is, for example, “USER 1”, “USER 2”, “USER 3”, and “USER 4”. Further, “Total” of the information of the column of “user ID” indicates a total value of values relating to all users. The information of the column of “normal printing” is information of an execution amount of the normal printing. The information of the column of “normal printing” is, for example, “A1”, “A2”, “A3”, and “A4” indicating respective numeral values. Further, “Asum” of the information of the column of “normal printing” indicates a total value of values relating to all the users. The information of the column of “duplex printing” is information of an execution amount of the duplex printing. The information of the column of “duplex printing” is, for example, “D1”, “D2”, “D3”, and “D4” indicating respective numeral values. Further, “Dsum” of the information of the column of “duplex printing” indicates a total value of values relating to all the users. The information of the column of “intensive printing (2in1, 4in1)” is information of an execution amount of the intensive printing (2in1, 4in1). The information of the column of “intensive printing (2in1, 4in1)” is, for example, “N1”, “N2”, “N3”, and “N4” indicating respective numeral values. Further, “Nsum” of the information of the column of “intensive printing (2in1, 4in1)” indicates a total value of values relating to all the users. The information of the column of “printing with decoloring toner” is information of an execution amount of the printing with decoloring toner. The information of the column of “printing with decoloring toner” is, for example, “E1”, “E2”, “E3”, and “E4” indicating respective numeral values. Further, “Esum” of the information of the column of “printing with decoloring toner” indicates a total value of values relating to all the users. The information of these numbers may be, for example, information of the number of sheets printed, or information of the number of pages printed.

The information of the column of “eco-points” is information of a value of eco-points. The value of eco-points is a value of a result obtained by respectively multiplying coefficients z1, z2 and z3 by the amount of the duplex printing, the amount of the intensive printing and the amount of the printing with decoloring toner and adding multiplication values. These coefficients z1, z2 and z3 may be any value respectively. For example, these coefficients z1, z2 and z3 may be the same value or may include different values. The information of the column of “eco-points” is, for example, “P1”, “P2”, “P3”, and “P4” indicating respective numeral values. Further, “Psum” of the information of the column of “eco-points” indicates a total value of values relating to all the users.

In this way, in the image forming apparatus 100 according to the present embodiment, by carrying out management of an eco-point and display of a screen for recommending ecology, concern about the ecology can be increased for a user, and a load on environment can be reduced. In this way, in the image forming apparatus 100, a job contributing to the ecology is promoted.

In the image forming apparatus 100 according to the present embodiment, the external connection control section 304 controls the connection with the external device 210. The determination section 305 determines the type of the external device 210 connected with the image forming apparatus 100. The guidance control section 306 selects, on the basis of a determination result of the determination section 305, a message of guidance, and enables the display device to display the message.

Thus, in the image forming apparatus 100 according to the present embodiment, a message of suitable guidance can be displayed depending on the type of the external device 210.

In the image forming apparatus 100 according to the present embodiment, the determination section 305 determines whether or not the type of the external device 210 is the payment reception device. The guidance control section 306 selects a message of guidance based on whether the type of the external device 210 is the payment reception device.

Thus, in the image forming apparatus 100 according to the present embodiment, a message of suitable guidance can be displayed depending on whether the type of the external device 210 is the payment reception device.

In the image forming apparatus 100 according to the present embodiment, the guidance control section 306 enables the display device to display a message of guidance for recommending reduction of an amount of consumption of resources in a case in which the type of the external device 210 is the payment reception device.

Thus, in the image forming apparatus 100 according to the present embodiment, the ecology can be recommended for the user in a case in which the type of the external device 210 is the payment reception device.

In the image forming apparatus 100 according to the present embodiment, the guidance control section 306 enables the display device to display a message relating to decoloring as the message of the guidance for recommending reduction of an amount of consumption of resources.

Thus, in the image forming apparatus 100 according to the present embodiment, the ecology relating to the decoloring can be recommended for the user.

In the image forming apparatus 100 according to the present embodiment, the payment reception device is provided in a store. The guidance control section 306 enables the display device to display identifier information relating to a point of reduction of an amount of consumption of resources in a case in which the type of the external device 210 is the payment reception device.

Thus, in the image forming apparatus 100 according to the present embodiment, information relating to an eco-point can be notified to the user. Further, in the image forming apparatus 100 according to the present embodiment, it is possible to simplify work using an eco-point by the user by presenting identifier information such as two-dimensional barcode information.

In the image forming apparatus 100 according to the present embodiment, the determination section 305 determines whether or not the type of the external device 210 is the authentication device of the user. The guidance control section 306 selects a message of guidance based on whether the type of the external device 210 is the authentication device of the user.

Thus, in the image forming apparatus 100 according to the present embodiment, a message of suitable guidance can be displayed depending on whether the type of the external device 210 is the authentication device of the user.

In the image forming apparatus 100 according to the present embodiment, the guidance control section 306 enables the display device to display the message of the guidance for recommending reduction of an amount of consumption of resources in a case in which the type of the external device 210 is the authentication device of the user.

Thus, in the image forming apparatus 100 according to the present embodiment, the ecology can be recommended for the user in a case in which the type of the external device 210 is the authentication device of the user.

In the image forming apparatus 100 according to the present embodiment, the guidance control section 306 further selects a message of guidance on the basis of the content of a job.

Thus, in the image forming apparatus 100 according to the present embodiment, a message of suitable guidance can be displayed depending on the content of a job.

A processing method carried out by the image forming apparatus 100 according to the present embodiment includes a first step, a second step and a third step. The first step controls the connection with the external device 210. The second step determines the type of the external device 210 connected with the image forming apparatus 100. The third step selects, on the basis of a determination result, a message of guidance and enables the display device to display the message.

A non-transitory recording medium according to the present embodiment stores programs for realizing a first step, a second step and a third step in a computer of the image forming apparatus 100. The first step controls the connection with the external device 210. The second step determines the type of the external device 210 connected with the image forming apparatus 100. The third step selects, on the basis of a determination result, a message of guidance and enables the display device to display the message.

According to at least one embodiment described above, the image forming apparatus 100 has a function for changing, on the basis of the type of the external device 210, a message of guidance and displaying the changed message. In this way, the image forming apparatus 100 can display a message of suitable guidance depending on the type of the external device 210.

A program for realizing functions of an apparatus (for example, the image forming apparatus 100) according to the embodiment described above may be recorded in a recording medium. The recording medium is a computer readable recording medium. Processing may be carried out in such a manner that the program recorded in the recording medium may be read by a computer system and executed. The computer system may include hardware of an OS (Operating System) or a peripheral device or processor. The computer readable recording medium may be various storage devices. The storage device is, for example, a writable nonvolatile memory such as a flexible disk, a magneto-optical disk, a ROM (Read Only Memory), a flash memory and the like. The storage device is, for example, a portable medium such as a DVD (Digital Versatile Disc), a hard disk incorporated in a computer system and the like. The computer readable recording medium is, for example, a non-transitory recording medium.

Further, the program described above may be transmitted from a computer system in which the program is stored in a storage device to another computer system. This transmission may be, for example, transmission via a transmission medium. This transmission may be, for example, transmission by a transmission wave in a transmission medium.

Herein, the transmission medium for transmitting the program refers to a medium having a function for transmitting information. The transmission medium is, for example, a network (communication network) such as the Internet or a communication line (communication line) such as a telephone line.

Further, the program described above may be a program for realizing a part of the above-mentioned functions. Furthermore, the program described above may realize the above-mentioned functions by a combination with a program already recorded in the computer system. This may be a so-called difference file (difference program).

While certain embodiments have been described these embodiments have been presented by way of example only, and are not intended to limit the scope of the inventions. Indeed, the novel embodiments described herein may be embodied in a variety of other forms: furthermore various omissions, substitutions and changes in the form of the embodiments described herein may be made without departing from the spirit of the inventions. The accompanying claims and there equivalents are intended to cover such forms or modifications as would fall within the scope and spirit of the invention.

What is claimed is:

1. An image forming apparatus, comprising:
an external connection control section configured to control connection with an external device;
a determination section configured to determine a type of the external device connected with the image forming apparatus; and
a guidance control section configured to select, on the basis of a determination result of the determination section, a message of guidance and display the message on a display device.

2. The image forming apparatus according to claim 1, wherein
the determination section determines whether or not the type of the external device is a payment reception device; and
the guidance control section selects the message of the guidance based on whether the type of the external device is the payment reception device.

3. The image forming apparatus according to claim 2, wherein
the guidance control section enables the display device to display the message of the guidance for recommending reduction of an amount of consumption of resources in a case in which the type of the external device is the payment reception device.

4. The image forming apparatus according to claim 3, wherein
the guidance control section enables the display device to display a message relating to decoloring as the message of the guidance for recommending reduction of an amount of consumption of resources.

5. The image forming apparatus according to claim 4, wherein
the payment reception device is provided in a store; and
the guidance control section enables the display device to display identifier information relating to a point of reduction of an amount of consumption of resources in a case in which the type of the external device is the payment reception device.

6. The image forming apparatus according to claim 1, wherein
the determination section determines whether or not the type of the external device is an authentication device of a user; and
the guidance control section selects the message of the guidance based on whether the type of the external device is the authentication device of the user.

7. The image forming apparatus according to claim 6, wherein
the guidance control section enables the display device to display the message of the guidance for recommending reduction of an amount of consumption of resources in a case in which the type of the external device is the authentication device of the user.

8. The image forming apparatus according to claim 1, wherein
the guidance control section selects the message of the guidance based on the content of a job.

9. A processing method carried out by an image forming apparatus, comprising:
controlling connection between the image forming apparatus and an external device;
determining a type of the external device connected with the image forming apparatus; and
selecting, on the basis of a result of the determination, a message of guidance and displaying the message on a display device.

10. The processing method according to claim 9, further comprising
determining whether or not the type of the external device is a payment reception device; and
selecting the message of the guidance based on whether the type of the external device is the payment reception device.

11. The processing method according to claim 10, further comprising
displaying the message of the guidance for recommending reduction of an amount of consumption of resources in a case in which the type of the external device is the payment reception device.

12. The processing method according to claim 11, further comprising
displaying a message relating to decoloring as the message of the guidance for recommending reduction of an amount of consumption of resources.

13. The processing method according to claim 9, further comprising
the determination section determines whether or not the type of the external device is an authentication device of a user; and
the guidance control section selects the message of the guidance based on whether the type of the external device is the authentication device of the user.

14. The processing method according to claim 9, further comprising
selecting the message of the guidance based on the content of a job.

15. A non-transitory recording medium for storing a program in a computer in an image forming apparatus, the program operable to execute the acts comprising:
controlling connection between the image forming apparatus and an external device;
determining a type of the external device connected with the image forming apparatus; and
selecting, on the basis of a result of the determination, a message of guidance and displaying the message on a display device.

16. The non-transitory recording medium according to claim 15, further comprising
determining whether or not the type of the external device is a payment reception device; and
selecting the message of the guidance based on whether the type of the external device is the payment reception device.

17. The non-transitory recording medium according to claim 16, further comprising
displaying the message of the guidance for recommending reduction of an amount of consumption of resources in a case in which the type of the external device is the payment reception device.

18. The non-transitory recording medium according to claim 17, further comprising
displaying a message relating to decoloring as the message of the guidance for recommending reduction of an amount of consumption of resources.

19. The non-transitory recording medium according to claim 15, further comprising
the determination section determines whether or not the type of the external device is an authentication device of a user; and
the guidance control section selects the message of the guidance based on whether the type of the external device is the authentication device of the user.

20. The non-transitory recording medium according to claim 15, further comprising
selecting the message of the guidance based on the content of a job.
